(19) United States
(12) Patent Application Publication
(10) Pub. No.: US 2015/0358045 A1
(43) Pub. Date: Dec. 10, 2015

(54) ELECTRONIC DEVICE PROTECTING CASING

(71) Applicant: Ka Ming Benjamin LEE, HONG KONG (CN)

(72) Inventor: Ka Ming Benjamin Lee, North Point (HK)

(21) Appl. No.: 14/760,638

(22) PCT Filed: Jan. 14, 2014
(86) PCT No.: PCT/CN2014/070591

§ 371 Date: Jul. 13, 2015

(30) Foreign Application Priority Data
Jan. 15, 2013 (CN) 201310014267.1

(51) Int. Cl. H04B 1/3888; A45C 11/00

(52) U.S. Cl. CPC H04B 1/3888; A45C 11/00; A45C 2011/002; A45C 2011/003

(57) ABSTRACT

The present invention provides an electronic device protecting casing comprising a main basic part (10), a selective main part (20) and a plurality of accessories (30). The basic main part has a first protective layer (11) and a first engagement portion (13) arranged on the first protective layer (11); the selective main part (20) has a second protective layer (21) and a second engagement portion (22) arranged on the second protective layer (22), and is detachably mounted to the basic main part (10) by means of matching of the second engagement portion (22) and the first engagement portion (13) to make the first protective layer (11) and the second protective layer (21) form a protective structure to be mounted to the electronic device; the accessories are detachably mounted to the outer surfaces of the main basic part (10) and the selective main part (20) by means of a fastening structure. In the present invention, different protecting casings can be formed by selecting corresponding selective main parts (20), and a user does not need to replace all components of the protecting casing when replacing an electronic device.

### TECHNICAL FIELD OF THE INVENTION

The present invention relates to a protecting casing for an electronic device which can be a cellphone, a tablet computer, etc.

### BACKGROUND OF THE INVENTION

A traditional electronic device protecting casing generally has fixed dimensions, making the casing applicable to only one type of electronic device. After replacing an electronic device, a user needs to replace a corresponding protecting casing.

In addition, exterior patterns and colors of traditional electronic device protecting casings are preset and cannot be changed during the course of usage.

### SUMMARY OF THE INVENTION

An object of the present invention is to provide an improved electronic device protecting casing. According to the present invention, there is provided an electronic device protecting casing which includes a basic main part and a selective main part. The basic main part has a first protective layer and a first engagement portion provided on the first protective layer. The selective main part has a second protective layer and a second engagement portion provided on the second protective layer; the selective main part is detachably mounted to the basic main part by means of matching of the second engagement portion and the first engagement portion so that the first protective layer and the second protective layer together form a protective structure to be mounted to the electronic device.

In a preferred embodiment, the first engagement portion and the second engagement portion are a male-female fastener structure, in which a male fastener has a stud head and a shank, with the stud head located at an end of the shank.

In a preferred embodiment, the second protective layer has curved portions for gripping the sides of the electronic device.

In a preferred embodiment, the electronic device protecting casing includes one basic main part and at least two selective main parts.

In a preferred embodiment, the first protective layer is tabular.

In a preferred embodiment, the at least two selective parts are mounted on two or more sides of the basic main part.

In a preferred embodiment, the electronic device protecting casing further includes a plurality of accessories which are detachably mounted to the outer surfaces of the main basic part and the selective main part by means of a fastening structure.

In a preferred embodiment, the accessories include decorative accessories and functional accessories.

In a preferred embodiment, the first engagement portion and the second engagement portion form a detachable fastener structure.

In a preferred embodiment, of the first engagement portion and the second engagement portion, one is in the form of a dovetail-shaped protrusion and the other is a corresponding dovetail-shaped engagement slot.

In a preferred embodiment, the electronic device protecting casing is used as a protecting casing for a cellphone, a tablet computer, or one of other portable electronic products.

Among the electronic device protecting casings according to the preferred embodiments of the present invention, different protective cases may be formed by utilizing a corresponding selective main part. Thus, when replacing an electronic device, a user does not need to replace all components of a protecting casing. In addition, such protecting casing may be equipped with different accessories for decorative purposes or additional functionalities.

### BRIEF DESCRIPTION OF THE DRAWINGS

FIG. 1 is a schematic drawing of a protecting casing according to an embodiment of the present invention.

FIG. 2 is a schematic drawing of the protecting casing shown in FIG. 1 with accessories mounted thereto.

FIG. 3 is a schematic drawing of a basic main part of the protecting casing shown in FIG. 1.

FIG. 4 is a schematic lateral view of the basic main part shown in FIG. 3.

FIG. 5 is a schematic plan view of the basic main part shown in FIG. 3.

FIG. 6 is a schematic lateral view of and a perspective view of an engagement portion of the basic main part shown in FIG. 3.

FIG. 7 and FIG. 8 are the schematic drawings of a first selective main part of and a second selective main part of the protecting casing shown in FIG. 1, respectively.

FIG. 9 is a schematic lateral view of and a perspective view of an engagement portion of the selective main part shown in FIG. 7 or FIG. 8.

FIG. 10 is a schematic drawing of connection between a first engagement portion of the basic main part shown in FIG. 3, and a selective main part or an engagement portion of an accessory.

FIG. 11 is a schematic drawing of several accessories that the protecting casing shown in FIG. 3 uses.

FIG. 12 is a schematic drawing of an engagement portion of an accessory shown in FIG. 11.

FIG. 13 is a schematic drawing of a protecting casing according to another embodiment of the present invention.

FIG. 14 is a schematic drawing of a first selective main part of the protecting casing shown in FIG. 13.

### DETAILED DESCRIPTION OF THE INVENTION

The present invention relates to an electronic device protecting casing that can be mounted to an electronic device and protect an electronic device. Such electronic device can be a cellphone, a tablet computer, a multimedia player, etc.

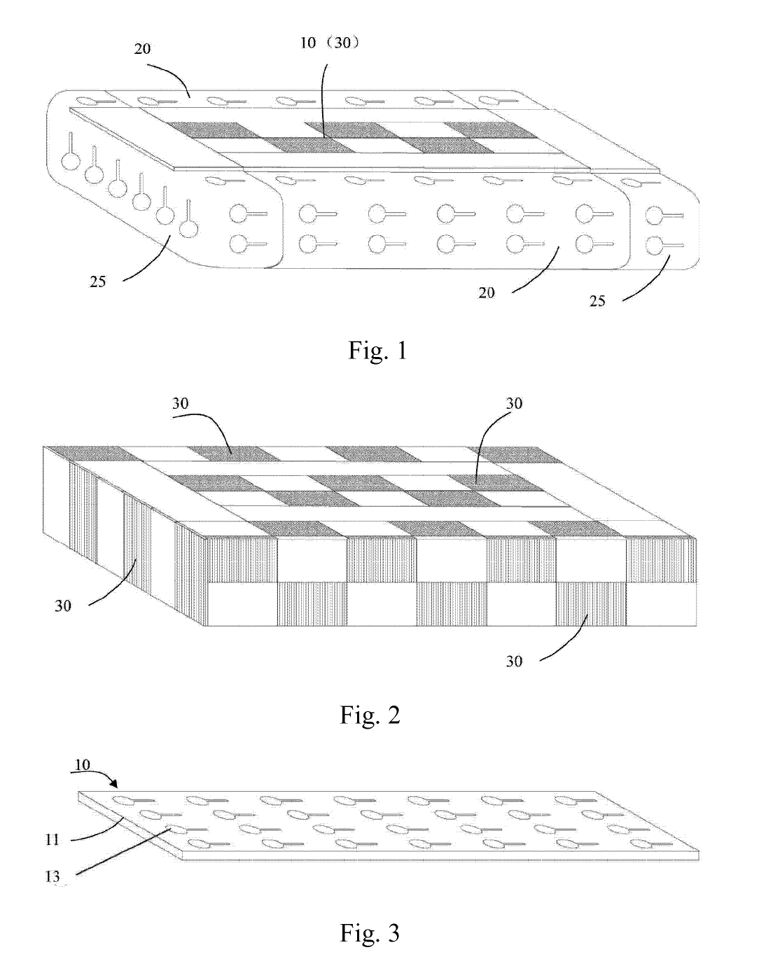

With reference to FIG. 1 and FIG. 2, the electronic device protecting casing according to this embodiment includes a basic main part 10, two first selective main parts 20, two second selective main parts 25 and a plurality of accessories 30. The accessory 30 is detachably mounted to the outer surfaces of the basic main part 10, the first selective main part 20 and the second selective main part 25.

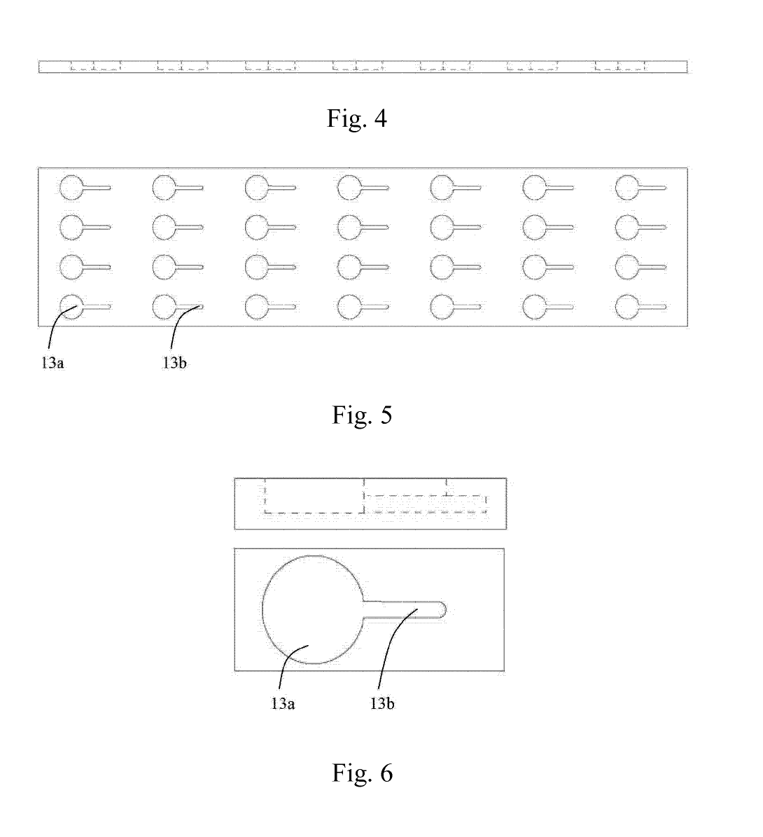

With reference to FIG. 3 to FIG. 6, the basic main part 10 has a first protective layer 11 and a first engagement portion 13 provided on the first protective layer 11. In this embodiment, the first protective layer 11 is tabular, and the first engagement portion 13 is a fastening hole. More specifically, the first engagement portion 13 includes a receiving chamber 13a and an opening 13b thereof. The receiving chamber 13a accommodates certain depth and width. The opening 13b extends along the width direction of the receiving chamber 13a, with one end having larger dimensions and the other having smaller dimensions.

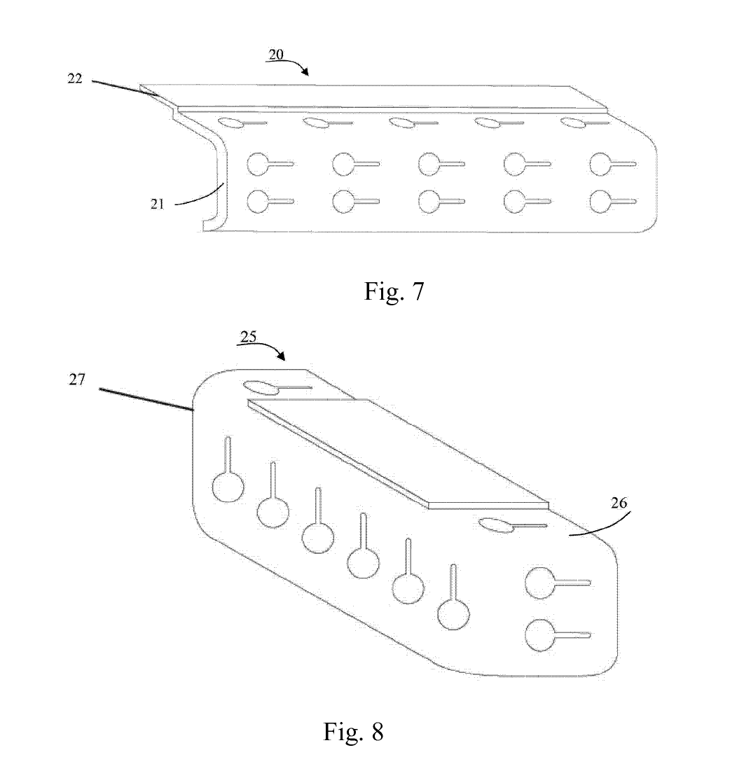

With reference to FIG. 7, the first selective main part 20 has a second protective layer 21 and a second engagement portion 22 provided on the second protective layer 21. The two first selective main parts 20 are mounted on two sides of the basic main part 10. The second protective layer 21 has curved portions for gripping the sides of an electronic device. Preferably, the second engagement portion 22 and the first engagement portion 13 of the basic main part 10 are a detachable pair; thus the selective main part 20 is detachably mounted to the basic main part 10 by means of matching of the second engagement portion 22 and the first engagement portion 13.

With reference to FIG. 8, the second selective main part 25 has a second protective layer 26 and a second engagement portion 27 provided on the second protective layer 26. The two second selective main parts 25 are mounted on another two sides of the basic main part 10. The second protective layer 26 has curved portions for gripping the sides of an electronic device. Preferably, the second engagement portion 27 and the first engagement portion 13 of the basic main part 10 are a detachable pair; thus the selective main part 20 is detachably mounted to the basic main part 10 by means of matching of the second engagement portion 27 and the first engagement portion 13.

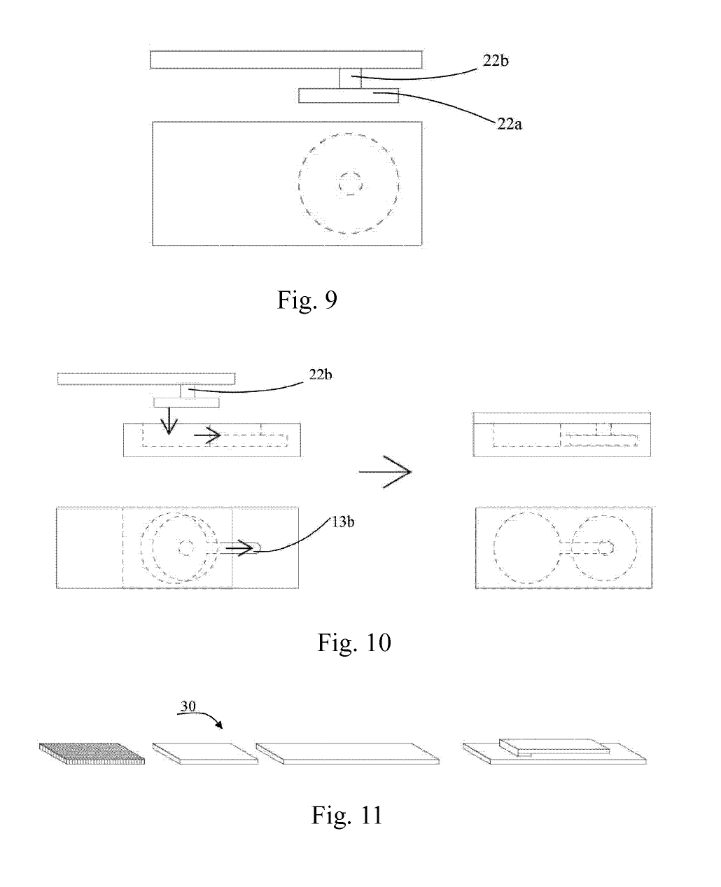

With reference to FIG. 9, the aforementioned second engagement portion 22 or 26 includes a stud head 22a and a shank 22b, the stud head 22a being located at an end of the shank 22b and the dimensions of the shank 22b being smaller than those of the stud head 22a.

With reference to FIG. 10, the stud head 22a may be mounted to the receiving chamber 13a of the first engagement portion and slide along the width direction of the receiving chamber 13a to a smaller part of the opening 13b to achieve detachable engagement.

In this way, the second selective main part 20 and the second selective main part 25 are detachably mounted to the basic main part 10, forming a protecting casing that can be mounted to an electronic device. The first protective layer 11, the second protective layer 21 and the second protective layer 26 together form a protective structure to protect an electronic device.

Thus, when replacing an electronic device, a user only needs to select a corresponding selective main part 21 and/or a corresponding selective main part 25 in order to be able to form a suitable protecting casing without having to replacing an entire protecting casing.

With reference to FIG. 1 and FIG. 2, the electronic device protecting casing further includes a plurality of accessories 30.

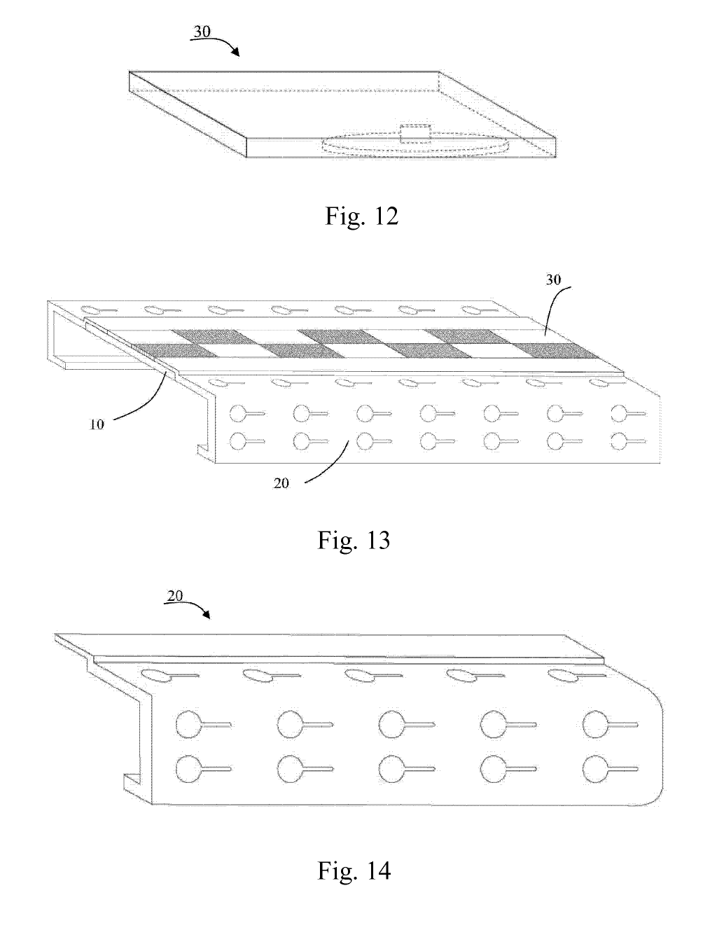

With reference to FIG. 11 and FIG. 12, an accessory 30 likewise has an engagement portion and is detachably mounted to the outer surfaces of the basic main part 10 and selective main parts 20, 25 by means of the fastening structure. The accessories 30 include decorative accessories and functional accessories. The decorative accessories generally serve aesthetic purposes. The functional accessories may be used to enhance the functions of the protecting casing. For instance, adding an accessory for photographic effect to the main part (basic main part 10 or selective main part 20, 25) may change the photographic effect of the photographic function of an electronic device. Depending on different shortcomings of different electronic devices, functional accessories can enhance the improvement brought by the protecting casing to an electronic device.

Preferably, the decorative accessories have different shapes, patterns, colors. In the course of using the protecting casing, a user may select and match different decorative accessories or may shift the positions of decorative accessories in order to change the appearance of the protecting casing.

It should be understood that the aforementioned engagement portions can be of other shapes. For example, of the first engagement portion 11 and the second engagement portion 22, one (such as the first engagement 11) is in the form of a dovetail-shaped protrusion, and the other (such as the second engagement 22) is a corresponding dovetail-shaped engagement slot. Preferably, both engagement portions use materials that can be elastically deformed in order to achieve detachable connection.

It should be understood that the basic main part and one of or a plurality of selective main parts may be treated as a single unit. Therefore, the protecting casing according to the present invention does not confine to two first selective main parts 20 and two second selective main parts 25. On the contrary, one basic main part may match with a plurality of selective main parts. A user may mount corresponding selective main parts according to a specific electronic device, or may mount suitable selective main parts to a replacement electronic device without the need to purchase new basic main parts and selective main parts.

With reference to FIG. 13 and FIG. 14, the protecting casing provided by another embodiment of the present invention only includes one basic main part 10, two first selective main parts 20, and a plurality of optional accessories 30.

Without departing from the inventive concept of the present invention, those skilled in the art can make various modifications and improvements which all fall within the scope of the present invention. Accordingly, the scope of protection of the present invention should be defined by the appended claims.

1. An electronic device protecting casing comprising: a basic main part (10) having a first protective layer (11) and a first engagement portion (13) provided on the first protective layer (11); a selective main part (20, 25) having a second protective layer (21, 26) and a second engagement portion (22, 27) provided on the second protective layer (21, 26), and detachably mounted to the basic main part (10) by means of matching of the second engagement portion (22, 27) and the first engagement portion (13) so that the first protective layer (11) and the second protective layer (21, 26) together form a protective structure to be mounted to an electronic device.

2: The electronic device protecting casing according to claim 1, wherein the first engagement portion (13) and the second engagement portion (22, 27) being a male-female fastening structure, wherein a male side of the fastening structure having a stud head (22a) and a shank (22b), the stud head (22a) being located at an end of the shank (22b).

3: The electronic device protecting casing according to claim 1, wherein the second protective layer (21, 26) having curved portions for gripping sides of the electronic device.

4: The electronic device protecting casing according to claim 2, wherein the electronic device protecting casing comprises one basic main part (10) and at least two selective main parts (20).

5: The electronic device protecting casing according to claim 3, wherein the first protective layer (11) is tabular.

6: The electronic device protecting casing according to claim 5, wherein the at least two selective main parts (20) are mounted on two or more sides of the basic main part (10).

7: The electronic device protecting casing according to claim 1, wherein the electronic device protecting casing further comprises a plurality of accessories (30) detachably mounted to outer surfaces of the main basic part (10) and the selective main part (20) by means of said fastening structure.

8: The electronic device protecting casing according to claim 1, wherein the first engagement portion (11) and the second engagement portion (21) form a detachable male-female fastening structure.

9: The electronic device protecting casing according to claim 8, wherein one of the first engagement portion (11) and the second engagement portion (21) being in the form of a dovetail-shaped protrusion, the other one being a corresponding dovetail-shaped engagement slot.

10: The electronic device protecting casing according to claim 1, wherein the electronic device protecting casing is a protecting casing for a cellphone, a tablet computer, or a multimedia player.

11: An electronic device protecting casing comprising:
a basic main part (10) having a first protective layer (11) and a first engagement portion (13) provided on the first protective layer (11);
a selective main part (20, 25) having a second protective layer (21, 26) and a second engagement portion (22, 27) provided on the second protective layer (21, 26), and detachably mounted to the basic main part (10) by means of matching of the second engagement portion (22, 27) and the first engagement portion (13) so that the first protective layer (11) and the second protective layer (21, 26) form a protective structure to be mounted to an electronic device,
wherein the first engagement portion (13) and the second engagement portion (22, 27) being a male-female fastening structure, wherein a male side of the fastening structure has a stud head (22a) and a shank (22b), the stud head (22a) located at an end of the shank (22b).

12: The electronic device protecting casing according to claim 11, wherein the electronic device protecting casing comprises one basic main part (10) and at least two selective main parts (20).

13: The electronic device protecting casing according to claim 11, wherein the first engagement portion (11) and the second engagement portion (21) form a detachable male-female fastening structure.

14: The electronic device protecting casing according to claim 13, wherein one of the first engagement portion (11) and the second engagement portion (21) being in the form of a dovetail-shaped protrusion, the other one being a corresponding dovetail-shaped engagement slot.

15: The electronic device protecting casing according to claim 11, wherein the electronic device protecting casing is a protecting casing for a cellphone, a tablet computer, or a multimedia player.

16: An electronic device protecting casing comprising: a basic main part (10) having a first protective layer (11) and a first engagement portion (13) provided on the first protective layer (11); a selective main part (20, 25) having a second protective layer (21, 26) and a second engagement portion (22, 27) provided on the second protective layer (21, 26), and detachably mounted to the basic main part (10) by means of matching of the second engagement portion (22, 27) and the first engagement portion (13) so that the first protective layer (11) and the second protective layer (21, 26) form a protective structure to be mounted to an electronic device, wherein the first engagement portion (11) and the second engagement portion (21) form a detachable male-female fastening structure.

17: The electronic device protecting casing according to claim 16, wherein one of the first engagement portion (11) and the second engagement portion (21) being in the form of a dovetail-shaped protrusion, the other one being a corresponding dovetail-shaped engagement slot.

18: The electronic device protecting casing according to claim 16, wherein the electronic device protecting casing is a protecting casing for a cellphone, a tablet computer, or a multimedia player.
